(19) United States
(12) Patent Application Publication
(10) Pub. No.: US 2019/0245320 A1
(43) Pub. Date: Aug. 8, 2019

(54) SOLID-STATE LASER SYSTEM

(71) Applicant: COMPOUND PHOTONICS LIMITED, London (GB)

(72) Inventor: Akheelesh K. Abeeluck, Phoenix, AZ (US)

(73) Assignee: COMPOUND PHOTONICS LIMITED, London, OT (GB)

(21) Appl. No.: 16/304,259

(22) PCT Filed: May 26, 2017
(86) PCT No.: PCT/US17/34839

§ 371 Date: Nov. 23, 2018

Related U.S. Application Data
(60) Provisional application No. 62/342,156, filed on May 26, 2016.
(60) Provisional application No. 62/342,841, filed on May 27, 2016.

(51) Int. Cl. H01S 3/109; H01S 3/102; H01S 3/16; H01S 3/094; H01S 3/0941; H01S 3/042; H01S 3/02; H01S 3/06

(52) U.S. Cl. CPC H01S 3/109; H01S 3/1022; H01S 3/1611; H01S 3/094049; H01S 3/0623; H01S 3/0941; H01S 3/042; H01S 3/025; H01S 3/1673

(57) ABSTRACT

A laser in an embodiment of the present invention is disclosed that includes a laser pump source, a pump-beam coupler (PBC) coupled with the laser pump source, a laser gain medium coupled with the PBC, a second-harmonic generator (SHG) coupled with the laser gain medium; and an output coupler coupled with the SHG.

### CROSS-REFERENCE TO RELATED APPLICATIONS

The present application claims priority to U.S. Provisional Patent Application No. 62/342,156, filed May 26, 2016, entitled “HIGH-POWER GREEN DIODE-PUMPED SOLID-STATE LASER,” and U.S. Provisional Patent Application No. 62/342,841, filed May 27, 2016, entitled “BROADBAND DIODE-PUMPED SOLID-STATE LASER,” the disclosures of which are hereby incorporated by reference in their entirety for all purposes except for those sections, if any, that are inconsistent with this specification.

### FIELD OF THE INVENTION

The present invention relates to lasers. More particularly, the present invention relates to pumped solid state laser systems and methods.

### BACKGROUND OF THE INVENTION

Diode pumped solid state lasers are known and involve utilizing a laser diode to pump light into a solid state gain medium. The solid state gain medium is typically a crystal material that is doped with one or more laser-active species. Solid state lasers may be designed to emit certain colors of light. However, challenges exist when designing a solid state laser to emit a particular color under particular design constraints or operating conditions.

### SUMMARY OF THE INVENTION

In an embodiment of the present invention, a diode-pumped solid-state laser (DPSSL) system and/or device is disclosed that may output high-power green laser light between and including approximately 2 W and 3.5 W at a high electrical-to-optical efficiency between and including approximately 20% and 25%, and have a compact footprint (e.g., an overall volume between and including approximately 0.5 cm³ to 0.6 cm³). In an embodiment of the present invention, a diode-pumped solid-state laser system and/or device, in accordance with the present invention, may be operated in a continuous-wave and/or quasi-continuous-wave mode.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A illustrates a solid state laser system and/or device in accordance with the present invention.

FIG. 1B illustrates a solid state laser system and/or device in accordance with the present invention.

FIG. 2 illustrates a beam shaping device and/or a pump beam coupler in accordance with the present invention.

FIG. 3A illustrates beam shaping elements in accordance with the present invention.

FIG. 3B illustrates a beam shaping device and/or a pump beam coupler in accordance with the present invention.

FIG. 4 illustrates metallized layers in accordance with the present invention.

FIG. 5A illustrates a periodically poled nonlinear optical device in accordance with the present invention. FIG. 5B illustrates a periodically poled nonlinear optical device in accordance with the present invention.

FIG. 6 illustrates a method of lasing in accordance with the present invention.

### DETAILED DESCRIPTION OF THE DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B,” “A or B,” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

In embodiments of the present invention, references to positions of components in a laser system and/or device 10a,10b refer to optical path positions.

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

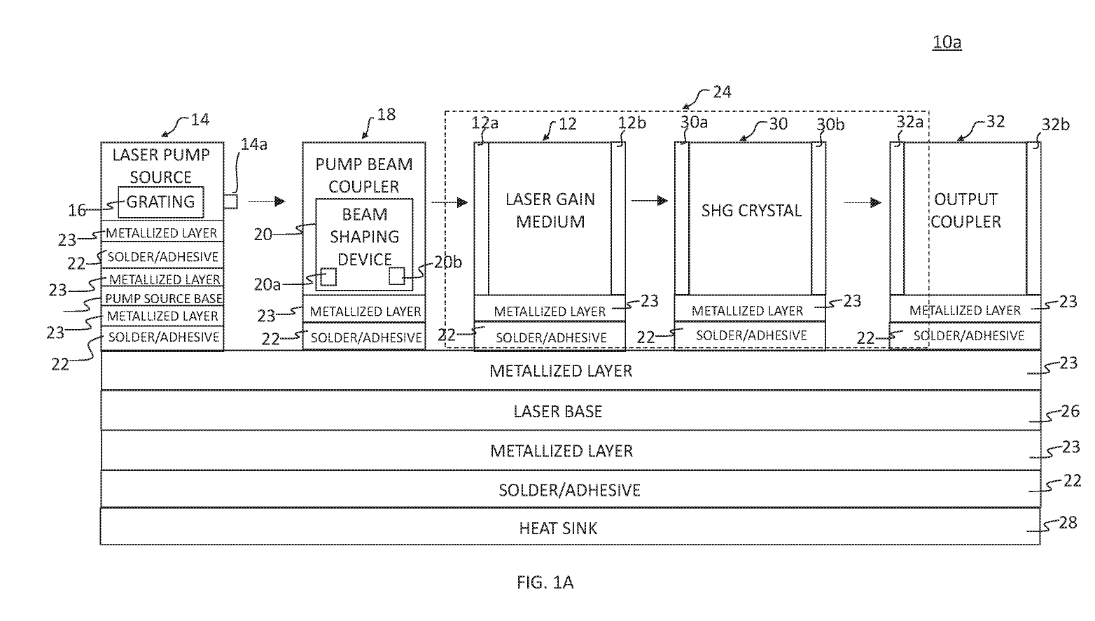

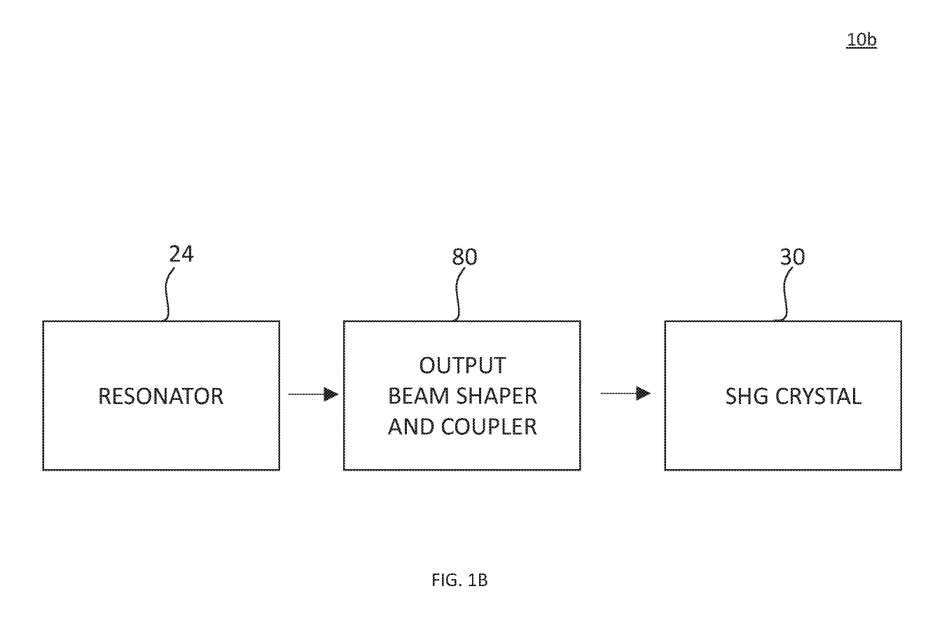

Shown in FIG. 1A is a laser device and/or system 10a in accordance with the present invention. A laser system and/or device 10a, in accordance with the present invention, includes a laser medium 12. In an embodiment of the present invention, the laser medium 12 is a laser gain medium. In an embodiment of the present invention, the laser medium 12 is pumped with a pump source 14 that generates electromagnetic radiation (e.g., light). Embodiments herein are described with reference to light for exemplary purposes. However, in all instances, the term “light” may be replaced with “electromagnetic radiation.” In an embodiment of the present invention, the pump source 14 is a laser pump source, for example a laser diode. In an embodiment of the present invention, the pump source 14 may include one or more emitters 14a. In an embodiment of the present invention, the pump source 14 is a single emitter pump source, for example, a single-emitter laser diode. It would be understood by one of ordinary skill in the art that other types of pump sources may be utilized, for example multi-emitter pump sources (for example, at least two laser diodes arranged in a bar and/or stack). For example, in an embodiment of the present invention, the pump source 14 has a wavelength of 880 nm or approximately 880 nm (e.g., 879.5 nm). In an embodiment of the present invention, the pump source 14 (e.g., a laser diode) may have a center wavelength in the range between and including 800 nm and 900 nm. In an embodiment of the present invention, the pump source 14 sits on a pump source base 14b, made from a thermally conductive material (e.g., BeO, CuW, sapphire and/or diamond). A pump source 14, in accordance with the present invention, may be coupled to the pump source base 14b, for example, via an attachment layer 22. In an embodiment of the present invention, an attachment layer 22 is made from a bonding substance, for example, an adhesive and/or metallic connection (e.g., solder). In an embodiment of the present invention, when the pump source 14 is coupled to the pump source base 14b via a metallic connection, the pump source 14 has a metallized layer 23 that is soldered to the pump source base 14b. For example, in an embodiment of the present invention, the pump source base 14b is made from CuW. In an embodiment of the present invention, a pump source base 14 is coupled to a laser base 26 via an attachment layer 22 and/or metallized layer 23.

In an embodiment of the present invention, the pump source 14 (e.g., a laser diode) is a wavelength-stabilized device (e.g., a frequency locked device) having a center wavelength in the range between and including 800 nm and 900 nm. In an embodiment of the present invention, the pump source 14 has a wavelength that is stabilized at 880 nm or approximately 880 nm (e.g., 879.5 nm).

All references to bandwidth herein refer to full width at half maximum (FWHM) bandwidth definition and measurements.

In embodiments of the present invention, a wavelength of the pump source 14, for example, a laser diode, is stabilized by incorporating, including, integrating, coupling, and/or placing an internal grating 16 in a cavity of the pump source 14 (e.g., a laser diode). By wavelength-stabilizing the pump source 14, for example, a laser diode, spectral shift of the light output from the pump source 14 with temperature is small (e.g., between and including approximately 0.05 nm per degree Celsius and 0.07 nm per degree Celsius). In an embodiment of the present invention, a pump source 14, in accordance with the present invention has a narrow spectral bandwidth (e.g., a bandwidth between and including approximately 0.1 nm and 0.5 nm) and provides, for example, operation of the laser system and/or device 10a,10b over a wide temperature range (for example between and including approximately 20 to 60 degrees Celsius). For example, in an embodiment of the present invention, the pump source 14 has a spectral bandwidth of approximately 0.5 nm and operates at a temperature of approximately 40 degrees Celsius. As the laser system and/or device 10a,10b, in accordance with the present invention operates across a wide temperature range, for example, the temperature range between and including approximately 20 to 60 degrees Celsius, a laser system and/or device 10a,10b, in accordance with the present invention, may be operated with passive cooling (e.g., by utilizing a passively cooled heat sink and/or without any powered cooling device) and/or active cooling (e.g., by utilizing a thermoelectric cooler (TEC)). The narrow spectral bandwidth and/or the small spectral shift with temperature of a pump source 14 (e.g., a laser diode), in accordance with the present invention, allows for efficient absorption of the pump source light by a laser medium 12, of the present invention (e.g., a laser medium 12 having a narrow absorption bandwidth). In an embodiment of the present invention, a laser medium 12, in accordance with the present invention, has an absorption bandwidth in a range between and including approximately 2 nm and 6 nm. For example, in an embodiment of the present invention, the laser medium 12 is an Nd:YVO₄ (neodymium-doped yttrium orthovanadate) material that has a FWHM absorption bandwidth of approximately 3.8 nm.

In an embodiment of the present invention, a pump source 14 (e.g., a laser diode), in accordance with the present invention, outputs a power in the range between and including approximately 3 W and 10 W. For example, in an embodiment of the present invention, the pump source 14, in accordance with the present invention, has an output power of approximately 6 W. In an embodiment of the present invention, a pump source 14 has a high power-conversion efficiency, for example, in the range between and including approximately 45% and 65% and, consequently, improves thermal management of the overall laser device and/or system 10a,10b. For example, in an embodiment of the present invention, the pump source 14, in accordance with the present invention, has a power-conversion efficiency of approximately 60%.

In an embodiment of the present invention, the dimensions of a pump source 14, in accordance with the present invention is, for example, approximately 3 mm in width, approximately 4 mm in length and approximately 0.5 mm in height, and such dimensions and/or approximate dimensions achieve a laser system/device 10a,10b, in accordance with the present invention, that is compact in size. In embodiments of the present invention, the width of a pump source 14, in accordance with the present invention, may be in the range of approximately between and including 2 mm and 4 mm, the length may be in the range of approximately between and including 1 mm and 5 mm, and the height may be in the range of approximately between and including 0.3 mm and 1 mm.

In an embodiment of a laser system and/or device 10a,10b, in accordance with the present invention, a pump beam coupler (PBC) 18 may be utilized to shape and/or couple an output (e.g., an optical output) from the pump source 14 to a laser medium 12. For example, in an embodiment of a laser system and/or device 10a,10b, in accordance with the present invention, a pump beam coupler 18 is utilized to optically shape and couple the output from the pump source 14.

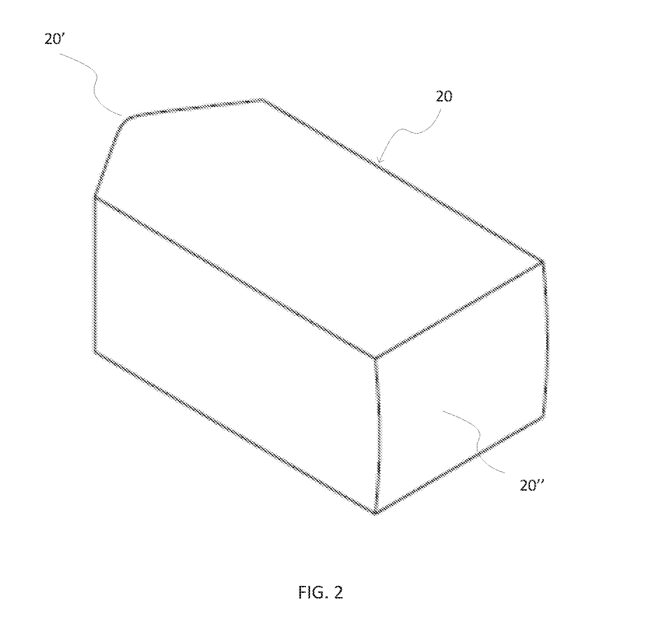

In an embodiment of the present invention, the pump beam coupler 18 includes a beam shaping device 20. A beam shaping device 20, in accordance with the present invention, may include one or more refractive optical elements (for example, lenses) and/or diffractive optical elements 20a,20b. For example, in an embodiment of the present invention, the beam shaping device 20a is a plano-convex cylindrical lens that may be utilized to shape and/or couple the pump beam from the pump source 14 to the laser gain medium 12 along the fast-axis of the pump source 14. For example, in an embodiment of the present invention, the beam shaping device 20b is a plano-convex cylindrical lens may be utilized to shape and/or couple the pump beam from the pump source 14 to the laser gain medium 12 along the slow-axis of the pump source. In an embodiment of the present invention, a laser system and/or device 10a,10b, in accordance with the present invention, a pump beam coupler 18 is a beam shaping device 20 that is a single lens, for example, the single lens shown in FIG. 2, that shapes the beam (e.g., beam of light) output from the pump source 14, along both the fast axis and the slow axis of the pump source 14.

In an embodiment of the present invention, as shown in FIG. 2, the beam shaping device 20 is a single lens, for example, a lens having approximate dimensions of 1 mm (length)×0.5 mm (height)×0.4 mm (width), and/or a radius of curvature for a first surface 20′ of the lens that may be approximately 0.4 mm for shaping and/or coupling the pump beam from the pump source 14 along the fast axis. In an embodiment of the present invention, the radius of curvature for a first surface 20′ of the single lens may be in the range of between and including approximately 0.2 mm and 0.6 mm. In an embodiment of the present invention, the beam shaping device 20 is a single lens that has a second surface 20″ that has a radius of curvature of approximately 1.5 mm for shaping and/or coupling the pump beam from the pump source 14 along the slow axis. In an embodiment of the present invention, the radius of curvature for a second surface 20″ of the single lens may be in the range of between and including approximately 0.6 mm and 2.5 mm. In an embodiment of the present invention, the beam shaping device 20 is a single lens that may have a height in the range of between and including approximately 0.25 mm and 0.75 mm, a width in the range of between and including approximately 0.3 mm and 0.6 mm, a length in the range of between and including approximately 0.75 mm and 1.5 mm. In an embodiment of the present invention, the pump beam coupler 18 corresponds to or is the beam shaping device 20. For example, in an embodiment of the present invention, the pump beam coupler 18 corresponds to the beam shaping device 20. In embodiments of the present invention, the small size of a pump beam coupler 18 and/or a beam shaping element 20 (e.g., a single lens), in accordance with the present invention, contributes to the compact size of the laser device and/or system 10a,10b. In an embodiment of the present invention, the first and second surfaces 20′ and 20″ are coated with anti-reflective (AR) coatings to minimize transmission loss of the pump beam from the pump source 14 through the pump beam coupler 18 and/or beam shaping device 20. Using a single lens as the pump beam coupler 18 and/or beam shaping device 20 (as opposed to two or more pump beam shaping elements and/or coupling elements 20a,20b) reduces the number of interfaces the pump beam passes through when traveling from the pump source 14 to the laser medium 12 and therefore reduces transmission loss of the pump beam. In embodiments of the present invention, the pump beam coupler 18 and/or beam shaping device 20 may be coupled to, integrated into, or incorporated in the pump source 14.

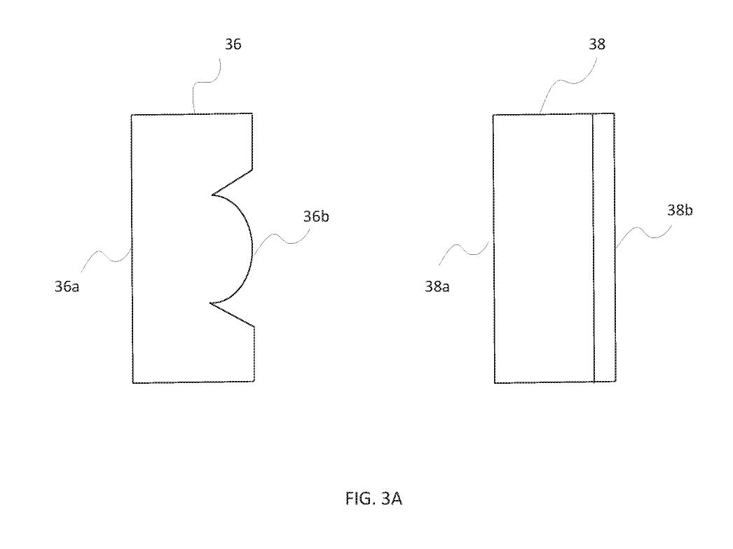

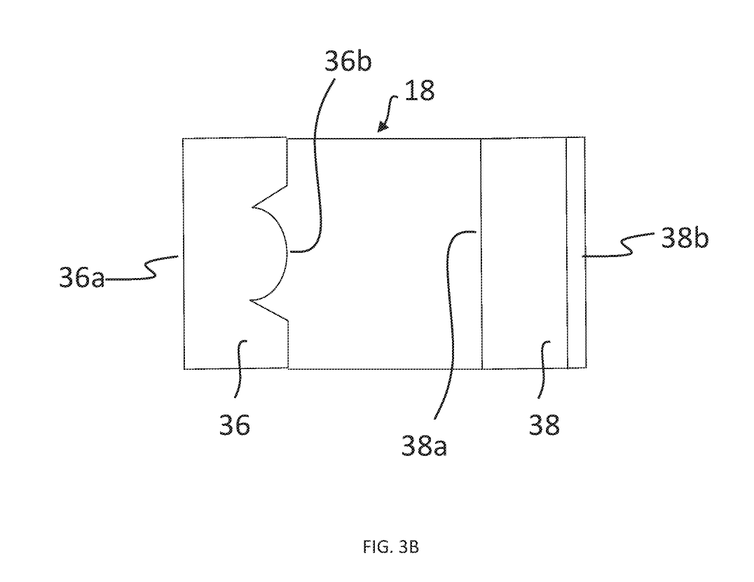

As shown in FIG. 3A, in an embodiment of the present invention, the pump beam coupler 18 may include one or more beam shaping elements 20 (e.g., lenses and diffractive optical elements). In an embodiment of the present invention, the pump beam coupler 18 may include one or more beam shaping elements 20a,20b, for example, one or more fast-axis lens 36 and/or slow-axis lens 38. For example in FIG. 3B, a pump beam coupler 18, in accordance with the present invention, includes two beam shaping elements 20a,20b, corresponding to, a fast axis lens 36 and a slow axis lens 38, respectively. In an embodiment of a pump beam coupler 18, in accordance with the present invention, the fast axis lens 36 may have a focal length in the range of 0.2 mm and 0.4 mm. In an embodiment of a pump beam coupler 18, in accordance with the present invention, the slow axis lens 38 may have a focal length in the range of 0.4 mm and 2 mm. For example, in an embodiment of a pump beam coupler 18, in accordance with the present invention, one beam shaping element 20a,20b is a fast axis lens 36 having a focal length of approximately 0.286 mm. For example, in an embodiment of a pump beam coupler 18, in accordance with the present invention, one beam shaping element 20a,20b is a slow-axis lens 38 having a focal length of approximately 0.9 mm. In an embodiment of the present invention, one beam shaping element 20a,20b is a fast axis lens 36 that may have a height in the range of between and including approximately 0.5 mm and 2 mm, a width in the range of between and including approximately 0.25 mm and 1.5 mm, a length in the range of between and including approximately 0.25 mm and 1.5 mm. In an embodiment of the present invention, one beam shaping element 20a,20b is a slow axis lens 38 that may have a height in the range of between and including approximately 0.8 mm and 2.5 mm, a width in the range of between and including approximately 0.8 mm and 2.5 mm, a length in the range of between and including approximately 0.8 mm and 2.5 mm. For example, in an embodiment of a pump beam coupler 18, in accordance with the present invention, one beam shaping element 20a,20b is a fast axis lens 36 having approximate dimensions of 1.5 mm (height)×0.5 mm (width)×0.5 mm (length). In an embodiment of a pump beam coupler 18, in accordance with the present invention, one beam shaping element 20a,20b is a slow-axis lens 38 having approximate dimensions of 1.6 mm (height)×1.2 mm (width)×2 mm (length). In an embodiment of the present invention, the fast-axis and the slow-axis lenses 36,38 may be, for example, manufactured by LIMO Lissotschenko Mikrooptik GmbH and/or Doric lenses. In an embodiment of the present invention, the pump beam coupler 18 optically shapes the light from the pump source 14 and, in an embodiment of the present invention, couples the optically shaped light to a laser medium 12, for example, a solid-state laser gain medium. In an embodiment of the present invention, the first and second surfaces 36a and 36b of the fast-axis lens 36 are coated with AR coatings to minimize transmission loss of the pump beam from the pump source 14 through the fast-axis lens. In an embodiment of the present invention, the first and second surfaces 38a and 38b of the slow-axis lens 38 are coated with AR coatings to minimize transmission loss of the pump beam from the pump source 14 through the slow-axis lens.

In embodiments of the present invention, the coatings may include one or more same materials, different materials, and/or combination of materials, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings forming the AR surfaces on the first and second surfaces (i.e., optical facets) of the pump beam shaping elements 20a,20b of the pump coupler 18 may include, for example, dielectric stacks (e.g., alternating layers) of Ta₂O₅ and SiO₂, TiO₂ and SiO₂, and/or HfO₂ and SiO₂. For example, in an embodiment of the present invention, the single lens beam shaping device 20 shapes and couples 880 nm light from the pump source 14 to the laser gain medium 12 with low transmission loss via utilization of, for example, a Ta₂O₅ and SiO₂ dielectric stack as an AR for the first surface 20′ and a Ta₂O₅ and SiO₂ dielectric stack as AR for the second surface 20″. In an embodiment of the present invention, the fast-axis lens 36 shapes and couples 880 nm light from the pump source 14 to the laser gain medium 12 with low transmission loss via utilization of, for example, a Ta₂O₅ and SiO₂ dielectric stack as an AR for the first surface 36a and a Ta₂O₅ and SiO₂ dielectric stack as AR for the second surface 36b. In an embodiment of the present invention, the slow-axis lens 38 shapes and couples 880 nm light from the pump source 14 to the laser gain medium 12 with low transmission loss via utilization of, for example, a Ta₂O₅ and SiO₂ dielectric stack as an AR for the first surface 38a and a Ta₂O₅ and SiO₂ dielectric stack as AR for the second surface 38b.

In an embodiment of the present invention, a laser system and/or device 10a,10b, in accordance with the present invention, includes a laser medium 12. In an embodiment of the present invention, the laser medium 12 is included in a laser resonator 24 in accordance with the present invention. References to intracavity wavelengths refer to wavelengths inside of the laser resonator 24. In an embodiment of the present invention, the laser resonator 24 may include a nonlinear optical device 30 and/or a first surface 32a of an output coupler 32. In an embodiment of a laser system and/or device 10a, in accordance with the present invention, the nonlinear optical device 30 is a frequency doubling device (e.g., a second harmonic generator (SHG) material and/or crystal).

In an embodiment of the present invention, a nonlinear optical device 30 may be external to the resonator 24 (i.e., the laser cavity of a laser system and/or device 10b in accordance with the present invention), as shown in FIG. 1B. In this embodiment, the resonator 24, as shown in FIG. 1B, may be optimized to output high-power IR light (e.g., in the range between approximately and including 1 W and 8 W) that may be shaped and/or coupled using an output beam shaper and coupler 80 to the nonlinear optical device 30 for generation of frequency-doubled light. In an embodiment of the present invention, the output beam shaper and coupler 80 may include one or more refractive and/or diffractive optical elements.

In an embodiment of the present invention, laser medium 12 has a first surface 12a and a second surface 12b. The first surface 12a receives light output from a pump source 14, for example, via a pump beam coupler 18. In an embodiment of the present invention, the laser medium 12 may receive light directly from the pump source 14. The second surface 12b is on a side of the laser medium 12 where light is outputted or emitted from the laser medium 12 (e.g., infrared (IR) light). In an embodiment of the present invention, the light emitted from the laser medium 12 is outputted, for example, to a nonlinear optical device 30. In an embodiment of the present invention, when the nonlinear optical device 30 is external to the laser resonator 24, the light emitted from the laser medium 12 may be received directly by the output coupler 32 and, in this embodiment of the present invention, the output coupler 32 may then output light that is received by the nonlinear optical device 30.

In an embodiment of a laser medium 12, in accordance with the present invention, a first surface 12a of the laser medium 12 may be an anti-reflector (AR) at the pump source 14 (e.g., laser diode) pump wavelength and a high reflector (HR) at the intracavity infrared (IR) lasing wavelength. In an embodiment of a laser medium 12, in accordance with the present invention, a second surface 12b may be an AR at the intracavity IR lasing wavelength (i.e., intra resonator IR lasing wavelength), and an HR or AR at the pump wavelength.

For example, in an embodiment of the present invention, a laser medium 12 has a first surface 12a that is an AR at the pump source 14 wavelength and an HR at the intracavity IR lasing wavelength, and has a second surface 12b that is an AR at the intracavity IR wavelength and an HR at the pump source 14 wavelength, thereby achieving double-passing of the pump beam in the laser medium 12, and enhancing pump absorption efficiency. Double-passing of the pump beam in the laser medium 12 enables reducing the size of the laser medium 12 and thus, making the laser system and/or device 10a,10b compact in size.

In embodiments of the present invention, the first and second surfaces (e.g., optical facets) 12a,12b of the laser medium 12 are coated with one or more materials and/or material systems. In embodiments of the present invention, the reflectivity and/or transmissivity of the coating materials and/or material systems of the first and second surfaces 12a,12b correspond to coating materials and/or material systems that reflect and/or transmit the wavelength of light (1) generated in the resonator 24 and/or (2) received and/or outputted external to the resonator 24. In an embodiment of the present invention, a coating may serve more than one purpose (e.g., dual purposes), for example, the coating may be an anti-reflector (AR) coating for one wavelength and an AR for another wavelength, an AR for one wavelength and a high reflector (HR) for another wavelength, or an HR for one wavelength and an HR for another wavelength.

In embodiments of the present invention, the coatings on the first and second surfaces of the laser medium 12 may include one or more same, different materials, and/or combination of materials, for example, dielectric materials. In embodiments of the present invention, the coatings on the first and second surfaces of the laser medium 12 may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings may include, for example, dielectric stacks (e.g., alternating layers) of Ta₂O₅ and SiO₂, TiO₂ and SiO₂, and/or HfO₂ and SiO₂. In embodiments of the present invention, the laser medium 12 achieves an intracavity IR wavelength of 1064 nm or approximately 1064 nm via utilization of, for example, a Ta₂O₅ and SiO₂ dielectric stack as AR (at 880 nm) and HR (at 1064 nm) for the first surface 12a and a Ta₂O₅ and SiO₂dielectric stack as AR (at 1064 nm) and HR (at 880 nm) for the second surface 12b.

In an embodiment of the present invention, the laser medium 12 may include an Nd:YVO₄ crystal having a length between approximately 1 mm and 8 mm, with a uniform or near uniform Nd³⁺ doping level between and including approximately 0.2 at. % and 2 at. %. In an embodiment of the present invention, a laser medium 12 is an Nd:YVO₄ crystal that has a fluorescence bandwidth of about 1 nm at a peak wavelength of approximately 1064 nm. In an embodiment of the present invention, the Nd:YVO₄ crystal length is sized to approximately 4 mm, with a uniform or near uniform Nd³⁺ doping level of approximately 0.5 at. %. In an embodiment of the present invention, the laser medium 12 may include, for example, Nd:YAG, Nd:CALGO, Yb:YAG, Yb: KYW, Yb:CALGO, and/or Yb:YVO₄ crystals. In an embodiment of the present invention, the doping level of the laser medium 12 and/or the length of the laser medium 12 achieves a laser medium 12 that is compact in size and, consequently, provides a laser medium 12 and/or laser system and/or device 10a,10b, in accordance with the present invention, that is compact.

The length selections and doping levels of embodiments of a laser medium 12, in accordance with the present invention, achieve thermal management of the laser medium 12, prevent thermal roll-over of a laser device and/or system 10a,10b, and/or enable high-power operation of the laser device and/or system 10a,10b. The length of the laser medium 12 and uniform or near-uniform doping level of the laser medium 12 distributes the pump light absorption uniformly or near uniformly throughout the laser medium 12. Consequently, the heat load of the laser medium 12 may be distributed uniformly or near uniformly throughout the laser medium 12, the peak temperature of the laser medium 12 may be reduced, and/or thermal lensing in the laser medium 12, which could cause a resonator to become unstable, is mitigated.

In an embodiment of the present invention, a pump source 14, a pump base 14b, a pump beam coupler 18, a laser medium 12, a nonlinear optical device 30 and/or an output coupler 32 may be attached to, integrated with, and/or coupled to a laser base 26 via an attachment layer 22. In an embodiment of the present invention, the laser base 26 may be made from, for example copper.

In an embodiment of the present invention, components of a laser system and/or device 10a,10b, in accordance with the present invention may be coupled to each other via, for example, bonding and soldering methods. For example, components, in accordance with the present invention may be coupled as follows: (1) a pump beam coupler 18, laser medium 12, nonlinear optical device 30, and/or output coupler 32 may be bonded to a laser base 26; (2) a pump beam coupler 18, laser medium 12, nonlinear optical device 30, and/or output coupler 32 may be soldered to the laser base 26; (3) a laser base 26 may be bonded and/or soldered to heat sink 28; (4) a pump source 14 may be bonded and/or soldered to a pump base 14b; and (5) a pump source 14 (with or without a pump source base 14b) may be bonded and/or soldered to a laser base 26.

In an embodiment of the present invention, components of a laser system and/or device 10a,10b, in accordance with the present invention, may be bonded by utilizing an adhesive, for example, an epoxy and/or thermal grease. In an embodiment of the present invention, the pump beam coupler 18, nonlinear optical device 30, output coupler 32 of the present invention are bonded to a laser base 26 with an epoxy, for example, a UV-curable epoxy. In an embodiment of the present invention, an epoxy is utilized that has low linear shrinkage (e.g., in the range of approximately between and including 0.05% to 1%). In an embodiment of the present invention, an epoxy (e.g., UV-curable epoxy Low Shrink™ OP-61-LS from Dymax Corporation) that has a low shrinkage (e.g., <0.1%) is utilized to bond components of the laser system and/or device 10a,10b, in accordance with the present invention, to each other, for example, to bond the pump beam coupler 18, nonlinear optical device 30 and/or output coupler 32 to the laser base 26. In an embodiment of the present invention, the laser medium 12 may be bonded to the laser base 26 with a low-outgassing epoxy of high thermal conductivity (e.g., in the range of approximately between and including 1 W/(mK) to 5 W/(mK)), and achieves efficient heat transfer from the laser medium 12 to the laser base 26. For example, in an embodiment of the present invention, a two-part, low-outgassing, thermally conductive silicone (e.g., CV-2946 from Nusil) may be used to bond the laser medium 12 to the laser base 26.

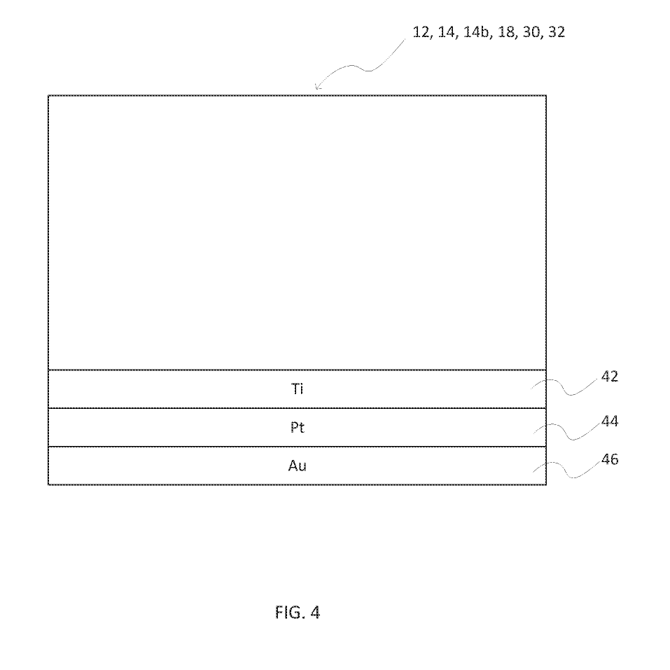

In an embodiment of the present invention, components of a laser system and/or device 10a,10b, in accordance with the present invention, may be bonded by utilizing a solder, for example, AuSn, InSn, In, InAg and/or SAC solder. In embodiments of the present invention, at least one of two components that are soldered together, for example, of a laser system and/or device 10a,10b, in accordance with the present invention, is metallized before being soldered to another component of a laser system and/or device 10a,10b in accordance with the present invention. In embodiments of the present invention, components of a laser system and/or device 10a,10b are metallized with one or more metals and/or combination of metals, for example, metals or combinations of metals that include Ti, Pt, Au, Cr, and/or Ni. For example, in an embodiment of the present invention, a plurality of metal layers utilized include layers of, for example, Ti, Pt, Au, Cr, and/or Ni. In an embodiment of the present invention, a surface of a component in laser system and/or device 10a,10b, in accordance with the present invention is metallized with at least a first layer of metal, a second layer of metal, and a third layer of metal. In an embodiment of the present invention, as shown in FIG. 4, a surface of a component 12,14, 14b, 18, 30 and/or 32 of a laser system and/or device 10a,10b, in accordance with the present invention, may be metallized with at least one layer of metal 42, 44, 46. In an embodiment of the present invention, a surface of a component of a laser system and/or device 10a, 10b, in accordance with the present invention is metallized with at least a layer of Ti, a layer of Pt, and/or a layer of Au. For example, as shown in FIG. 4, a surface of a component of a laser system and/or device 10a,10b, in accordance with the present invention is metallized with at least a layer of Cr, a layer of Ni, and a layer of Au. It would be understood by one of ordinary skill in the art that the number of layers and/or the order of layers may vary. In an embodiment of the present invention, a laser system and/or device 10a,10b has a pump source 14 that is soldered to a Ti/Pt/Au-metallized pump source base 14b using AuSn solder, a Ti/Pt/Au-metallized pump source base 14b is soldered to a NiAu-plated laser base 26 using SAC solder, and/or a Ti/Pt/Au-metallized laser medium 12 is soldered to a NiAu-plated laser base using InSn solder.

In an embodiment of the present invention, heat dissipation from a component of a laser system and/or device 10a,10b is achieved by metallizing a surface of the component of a laser system and/or device 10a,10b with layers of metals, for example, layers of (1) Ti, Pt, and Au or (2) Cr, Ni, and Au or (3) Ni and Au.

In an embodiment of the present invention, the laser base 26 may be bonded and/or soldered to the heat sink 28. In an embodiment of the present invention, the laser base 26 is soldered to the heat sink 28 with a solder, for example, InSn, In and/or SAC solder. In an embodiment of the present invention, the laser base 26 is bonded to the heat sink 28 using a thermally conductive epoxy.

In an embodiment of the present invention, heat transfer between the laser medium 12 and the heat sink 28 is improved when the laser medium 12 height is reduced to, for example, between and including approximately 0.5 mm and 3 mm. In an embodiment of the present invention, the height of the laser medium 12 is reduced to 2 mm.

In a laser system and/or device 10a,10b, in accordance with embodiments of the invention, the dopant concentration of the laser medium 12, and/or the radius of the pump beam received from, for example, the pump beam coupler 18, into the laser medium 12 (e.g., the received pump beam has a radius between and including approximately 50 microns and 200 microns) provide for the pump absorption and the heat load to be distributed more uniformly in the laser medium 12. With more uniform heat distribution in the laser medium 12, the temperature of the laser medium 12 is more uniform, the peak temperature of the laser medium 12 is lower, and thermal lensing, which could occur in the laser medium 12 due to the heat load and cause the resonator to become unstable, is mitigated. A laser system and/or device 10a,10b in accordance with the present invention achieves more uniform heat distribution in the laser medium and provides for more efficient thermal management of the laser medium 12 and/or the laser system and/or device 10a,10b of embodiments of the present invention.

In an embodiment of the present invention, laser system and/or device 10a,10b, in accordance with the present invention may include a nonlinear optical device 30 (e.g., a frequency doubling device) that is internal or external to the laser resonator 24 and that generates an output based on one or more nonlinear optical processes. In an embodiment of the present invention, the nonlinear optical device 30 is a frequency doubling device, for example, a second-harmonic generating (SHG) crystal.

In an embodiment of the present invention, the first and second surfaces 30a,30b of the nonlinear optical device 30 are coated with one or more materials and/or material systems that are tailored to reflect and/or transmit wavelength of light generated either in the resonator 24 or external to the resonator 24. In an embodiment of the present invention a coating for the nonlinear optical device 30 may serve more than one purpose (e.g., dual purposes), for example, the coating may be an anti-reflector (AR) coating for one wavelength and an AR for another wavelength, an AR for one wavelength and a high reflector (HR) for another wavelength, or an HR for one wavelength and an HR for another wavelength.

In an embodiment of the present invention, the nonlinear optical device 30 has a first surface (i.e., optical facet) 30a on an end of the nonlinear optical device 30 that receives light from the laser medium 12 and a second surface (i.e., optical facet) 30b on a side of the nonlinear optical device 30 that outputs light. In an embodiment of the present invention, the first surface 30a may be an

AR at the intracavity IR wavelength and couples the intracavity IR light into the nonlinear optical device 30. In an embodiment of the present invention, the first surface 30a of the nonlinear optical device 30 may be an AR at the wavelength of the nonlinear optical device 30 (e.g., at the frequency doubled wavelength). In an embodiment of the present invention, the first surface 30a of the nonlinear optical device 30 may be an HR at the wavelength of the nonlinear optical device 30 (e.g., at the frequency doubled wavelength) to prevent nonlinear optical device 30 light (e.g., at the frequency doubled wavelength) from being coupled into, absorbed and/or scattered by the laser medium 12. For example, in an embodiment of the present invention, a laser medium 12 that includes or is made from Nd:YVO₄ absorbs visible light (e.g., at 532 nm or approximately 532 nm, i.e., green light). Having an HR on the first surface 30a of the nonlinear optical device 30 at the frequency doubled wavelength (e.g., at 532 nm or approximately 532 nm, i.e., green light) prevents the frequency doubled light from going into the Nd:YVO₄ crystal. Consequently, thermal load on the laser medium 12 and/or the laser system and/or device 10a is mitigated and allows for the laser system and/or device 10a to be operated under passive cooling.

In an embodiment of the present invention, a second surface 30b of the nonlinear optical device 30 may be coated with a material that is an AR at the intracavity IR wavelength of the resonator 24, and reduces intracavity IR laser power loss. The second surface 30b of the nonlinear optical device 30 may be an AR at the wavelength of the nonlinear optical device 30, and thereby reduces intracavity laser power loss at the intracavity nonlinear optical device 30 (e.g., SHG crystal) wavelength and/or allows the nonlinear optical device 30 light beam to exit the nonlinear optical device 30. In an embodiment of the present invention, a first surface 30a of the nonlinear optical device 30 is an AR at the wavelength of approximately 1064 nm and an HR at the wavelength of approximately 532 nm, and the second surface is an AR at the wavelength of approximately 1064 nm and an AR at the wavelength of approximately 532 nm.

In embodiments of the present invention, the coatings may include one or more same or different materials, material systems and/or combination of materials and material systems, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings forming the AR and/or HR surfaces on the first and second surfaces 30a,30b (i.e., optical facets) of the nonlinear optical device 30 may include, for example, dielectric stacks (e.g., alternating layers) of Ta₂O₅ and SiO₂, TiO₂ and SiO₂, and/or HfO₂ and SiO₂. In embodiments of the present invention, the nonlinear optical device 30 converts an intracavity IR wavelength of 1064 nm or approximately 1064 nm to 532 nm or approximately 532 nm via utilization of, for example, a Ta₂O₅/SiO₂ dielectric stack as an AR at 1064 nm and an HR at 532 nm for the first surface 30a, and a Ta₂O₅/SiO₂ dielectric stack as an AR at 1064 nm and an AR at 532 nm for the second surface 30b of the nonlinear optical device 30.

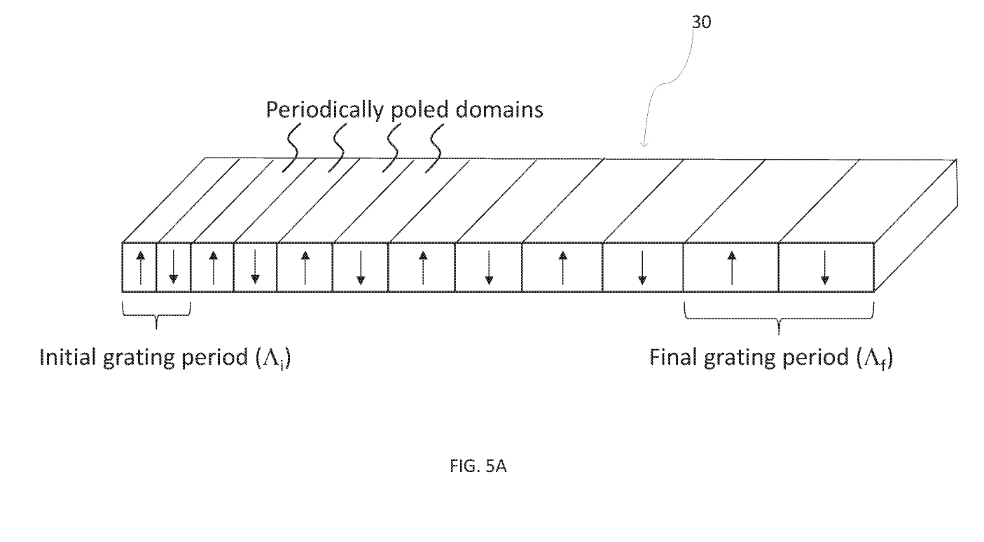

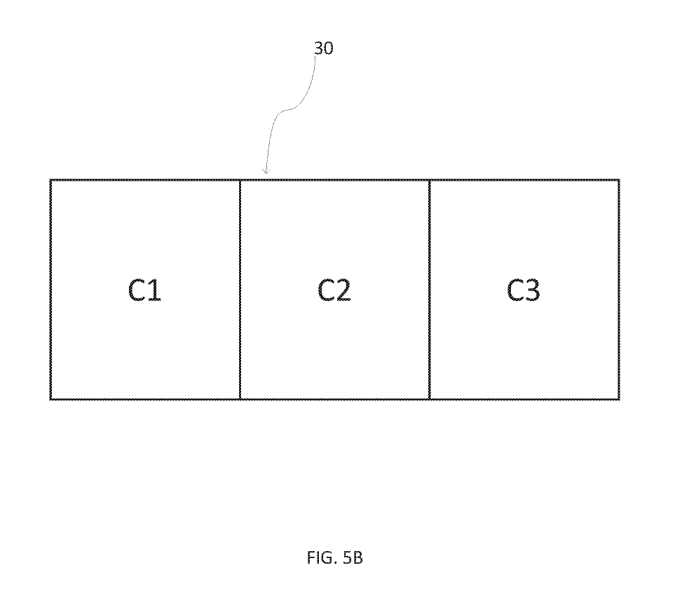

The nonlinear optical device 30 (e.g., SHG crystal) has a temperature bandwidth of between and including approximately 20 and 60 degrees Celsius with a typical operating temperature between and including approximately 40 and 45 degrees Celsius. In embodiments of the present invention, the nonlinear optical device 30 (e.g., SHG crystal) may be a periodically poled (PP) material, as shown in FIGS. 5A and 5B. A periodically poled material has periodic reversal of the domain orientation to yield a periodic reversal of the sign of the nonlinear coefficient of the nonlinear optical device 30, enabling operation over a wide wavelength range via the technique of quasi-phase matching (QPM). FIG. 5A illustrates a periodically poled nonlinear optical device 30, and the arrows shown in FIG. 5A indicate the poling direction of the poled domains. In embodiments of the present invention, the nonlinear optical device 30 may be chirped (e.g., by linearly chirping the QPM grating period across the nonlinear optical device 30 length). In an embodiment of the present invention, the nonlinear optical device 30 is a chirped PP SHG crystal, and the chirping rate (i.e., rate of change of the QPM grating period from surface 30a to surface 30b in spatial frequency space) provides an increased temperature bandwidth over which the nonlinear optical device 30 and/or a laser system and/or device 10a,10b, of the present invention, operates (e.g., approximately between and including 20 to 60 degrees Celsius).

In an embodiment of the present invention, the nonlinear optical device 30 may be periodically poled lithium niobate (PPLN). In other embodiments of the present invention the nonlinear optical device 30 may be, for example, periodically poled lithium tantalate (PPLT) and/or periodically poled potassium titanyl phosphate (PPKTP). In an embodiment of the present invention, the nonlinear optical device 30 may be chirped PPLN. In another embodiment of the present invention, the nonlinear optical device 30 may be chirped PPLT or chirped PPKTP.

As shown in FIG. 5A, an embodiment of a nonlinear optical device 30, in accordance with the present invention, may be a PPLN crystal having a length between and including approximately 1 mm and 3 mm, a linearly chirped grating (e.g., with initial and final grating periods Λᵢ and Λ_{f}, where Λᵢ and Λ_{f}, are approximately 6.89 microns and 7.01 microns, respectively, having a duty cycle of approximately 50%, and having an output beam of light that has a center wavelength of 532 nm or approximately 532 nm and a FWHM spectral bandwidth of approximately 0.3 nm.

In an embodiment, a nonlinear optical device 30 (e.g., an SHG crystal) is an approximately 2 mm long PPLN with a linearly chirped grating having initial and final grating periods of between and including approximately 6.89 microns and 7.01 microns, respectively, and 50% duty cycle, that outputs a beam of light having a center wavelength of 532 nm or approximately 532 nm and a FWHM spectral bandwidth of approximately 0.3 nm.

In an embodiment of a nonlinear optical device 30 of the present invention, as shown in FIG. 5B, a nonlinear optical device 30 (e.g., a periodically poled SHG device) may include multiple regions (e.g., C1, C2, C3) having linearly chirped gratings of the same and/or different chirp rates and approximately 50% duty cycle to achieve, for example, frequency doubling, over a wide range of nonlinear optical device 30 (e.g., SHG device) wavelengths and over a wide range of temperatures.

In another embodiment of a nonlinear device 30 of the present invention, as shown in FIG. 5B, the nonlinear device 30 may include multiple regions (e.g., C1, C2, C3) having fixed QPM grating periods (e.g., Λ₁, Λ₂, Λ₃) that may be the same or different.

In an embodiment of the present invention, the nonlinear optical device 30 may be a PPLT SHG crystal that has a higher damage threshold for green-induced IR absorption (GRIIRA) compared to PPLN, and achieves a laser system and/or device 10a,10b, in accordance with the present invention, that has high-power operation (e.g., output power greater than 3.5 W).

As shown in FIG. 1A, in an embodiment of the present invention an output coupler 32 may be utilized to receive the light beam exiting the nonlinear optical device 30 and outputs laser light, for example, green light. In an embodiment of the present invention, the first and second surfaces 32a,32b of the output coupler 32 are coated with one or more materials or material systems that are tailored to reflect and/or transmit wavelength of light generated (e.g., generated in the resonator 24).

In an embodiment of the present invention, a coating may serve more than one purpose (e.g., dual purposes), for example, the coating may be an anti-reflector (AR) coating for one wavelength and an AR for another wavelength, an AR for one wavelength and an high reflector (HR) for another wavelength, or an HR for one wavelength and an HR for another wavelength. In an embodiment of the present invention, a first surface 32a (i.e., a side that receives light from the nonlinear optical device 30) of the output coupler 32 may be utilized as an HR at the intracavity IR lasing wavelength, providing cavity-enhancement of the intracavity IR power and intensity due to optical feedback between 12a and 32a, and providing high conversion efficiency of the IR light in the nonlinear optical device 30 (e.g., SHG crystal) due to nonlinear optical effects (e.g., frequency doubling) into, for example, the frequency doubled light. The output coupler 32, of the present invention, receives the light output by the nonlinear optical device 30 (e.g., SHG crystal), and serves to increase the power output of the nonlinear optical device 30 (e.g., SHG crystal), and consequently, achieves a high electrical to optical (E-O) efficiency (e.g., in the range of approximately between and including 20% and 25%) of the laser system and/or device 10a (e.g., a green laser system and/or device), in accordance with the present invention.

In an embodiment of the present invention, a first surface 32a of the output coupler 32 is an AR at the nonlinear optical device 30 wavelength (e.g., the SHG wavelength) of 532 nm or approximately 532 nm. The output coupler 32 has a second surface 32b (i.e., a surface on a side of the output coupler that transmits light) that may be an AR at the intracavity IR wavelength of 1064 nm or approximately 1064 nm and at the frequency-doubled wavelength of 532 nm or approximately 532 nm. In an embodiment of the present invention, outcoupling of the residual leak IR light from the second surface 32b of the output coupler 32, in accordance with the present invention, prevents IR light from the laser resonator 24 from going back into the laser medium 12 and/or the laser resonator 24 that could destabilize the resonator.

In embodiments of the present invention, the first and second surfaces 32a,32b of the output coupler 32 are coated with one or more materials or material systems that are tailored to reflect and/or transmit wavelength of light generated. In embodiments of the present invention, the coatings on the output coupler 32 may include one or more same, different materials and/or combination of materials, for example, dielectric materials. In embodiments of the present invention, the coatings may include tantalum (Ta), silicon (Si), titanium (Ti), hafnium (Hf). In embodiments of the present invention, the materials may include at least one or more oxidized versions of Ta, Si, Ti, Hf. In embodiments of the present invention, the coatings forming the AR and/or HR surfaces on the first and second surfaces 32a,32b (i.e., optical facets) of the output coupler 32 may include, for example, dielectric stacks (e.g., alternating layers) of Ta₂O₅ and SiO₂, TiO₂ and SiO₂, and/or HfO₂ and SiO₂. In embodiments of the present invention, the output coupler 32 may transmit residual leaked light having a wavelength of approximately 1064 nm and light, for example, the frequency doubled light of approximately 532 nm, via utilization of, for example, a Ta₂O₅ and SiO₂ dielectric stack as an HR at approximately 1064 nm and an AR at approximately 532 nm for the first surface 32a and a Ta₂O₅ and SiO₂ dielectric stack as an AR at approximately 1064 nm and an AR at approximately 532 nm for the second surface 32b.

In an embodiment of the present invention, an output coupler 32 is positioned in a resonator 24 before the nonlinear optical device 30 (SHG crystal) that is positioned external to the resonator 24.

In an embodiment of the present invention, the output coupler 32 may be a plano-concave output coupler, having a surface that has a radius of curvature in the range between and including approximately 35 mm and 100 mm. In an embodiment of the present invention, the output coupler 32 is a plano-concave output coupler having a surface that has a radius of curvature of approximately 85 mm. In an embodiment of the present invention, the output coupler 32 may have a height in the range of 0.5 mm and 5 mm, a width in the range of 0.5 mm and 5 mm, and a length in the range of 0.5 mm and 5 mm. In an embodiment of the present invention, an output coupler 32, in accordance with the present invention, has dimensions of 2 mm×2 mm×0.5 mm. In an embodiment of the present invention, a first surface 32a of the output coupler 32 having a curved surface provides a stable resonator for a laser system/device 10a,10b and or resonator 24, in accordance with the present invention.

In an embodiment of the present invention, a laser system and/or device 10a,10b, utilizes surfaces having one or more curved surfaces, for example, surface 32a of the output coupler 32, does not rely on thermal lensing to stabilize the laser system in accordance with the present invention. To the contrary, laser systems where all of the laser resonator components have flat surfaces, typically rely entirely on thermal lensing in the laser gain medium for its stability.

In an embodiment of the present invention, the laser system and/or device 10a,10b is a green laser system and/or device, and includes a laser gain medium 12 having Nd:YVO₄ and a nonlinear optical device 30 that is a PPLN crystal as a frequency doubling device. A laser system and/or device 10a, in accordance with the present invention: has a center wavelength of 532 nm or approximately 532 nm; has a spectral bandwidth of approximately 0.3 nm; has a high output beam polarization ratio that is approximately greater than or equal to 100:1; has a high electrical-to-optical (E-O) efficiency of approximately between and including 20% and 25%; and/or achieves high output power of approximately 3.0 W. In an embodiment of the present invention, a diode-pumped solid-state laser system and/or device 10a,10b, in accordance with the present invention, may be operated in a continuous-wave and/or quasi-continuous-wave mode

In an embodiment of the present invention, a laser system/device 10a,10b, in accordance with the present invention, may have a length in the range of approximately between and including 10 mm and 25 mm, a width in the range of approximately between and including 4 mm and 10 mm, a height in the range of approximately between and including 2 mm and 6 mm, and a mass in the range of approximately between and including 1 g and 2 g. In an embodiment of the present invention, a laser system/device 10a has a length of approximately 21 mm, a width of approximately 8 mm, a height of approximately 3.8 mm, and a mass of approximately 1.5 g. It would be understood by one of ordinary skill in the art that the height, width, and length labels for the dimensions of components of the laser system and/or device system 10a,10b, in accordance with the present invention, may be interchanged (e.g., a dimension labeled as a width may be relabeled as the height for a particular component).

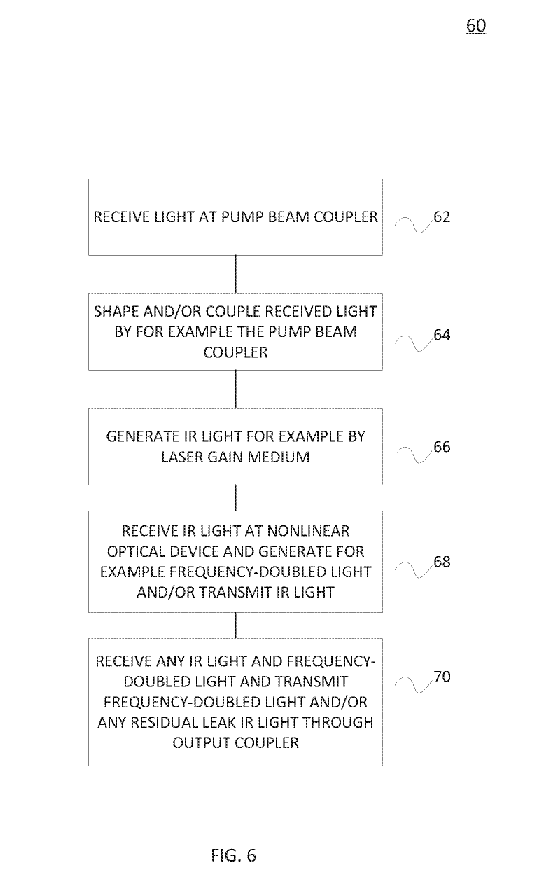

As shown in FIG. 6, a method 60 of lasing, in accordance with the present invention, may include, in step 62, receiving light at a pump beam coupler 18. In an embodiment of the present invention, the light may come from a pump source 14 (e.g., light source), for example, a laser diode. In step 64, the pump beam coupler 18 shapes and/or couples light received from the pump source 14. In step 66 the laser medium 12 (e.g., laser gain medium) receives light transmitted or emitted from, for example, the pump beam coupler 18 and generates infrared (IR) light. In step 68, the nonlinear optical device 30 (e.g., frequency doubling device) receives the IR light, from, for example, the laser medium 12, and nonlinearly converts the received IR light, for example, doubles the frequency of the IR light (e.g., doubles the frequency from approximately 1064 nm to approximately 532 nm). In an embodiment of the present invention, in step 68, the nonlinear optical device 30 may allow IR light from, for example, the laser medium 12, to pass through the nonlinear optical device 30. In an embodiment of the present invention, in step 70, the output coupler 32 receives the IR light from, for example the laser medium 12 and/or the nonlinearly converted light (e.g., the frequency doubled light) from the nonlinear optical device 30, reflects any received IR light back into the laser resonator 24, transmits the nonlinearly converted light (e.g., frequency doubled light) received and/or transmits any residual IR leaked from the laser resonator 24. In an embodiment of the present invention, step 70 may be performed before step 68 when the nonlinear optical device 30 is external to a laser resonator 24.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

Some non-limiting examples are provided below.

Example 1 includes a diode-pumped solid-state laser (DPSSL), comprising: a laser pump source; a pump-beam coupler (PBC) coupled with the laser pump source; a laser gain medium coupled with the PBC; a second-harmonic generator (SHG) coupled with the PBC; and an output coupler coupled with the SHG.

Example 2 includes a DPSSL of example 1, wherein the laser pump source comprises a single emitter.

Example 3 includes a DPSSL of example 1, wherein the laser pump source comprises a wavelength stable device.

Example 4 includes a DPSSL of example 3, wherein the wavelength stable device includes an internal grating.

Example 5 includes a DPSSL of example 3, wherein a spectral drift with temperature of the wavelength stable device is between and includes approximately 0.05 nm per degree Celsius and 0.07 nm per degree Celsius.

Example 6 includes a DPSSL of example 3, wherein a spectral bandwidth of the wavelength stable device is approximately between and includes 0.1 nm and 0.5 nm.

Example 7 includes a DPSSL of example 3, wherein the laser pump source has a center wavelength of approximately 880 nm.

Example 8 includes a DPSSL of example 1, wherein an operating temperature range of the laser pump source is between and includes approximately 20 degrees Celsius and 60 degrees Celsius.

Example 9 includes a DPSSL of example 1, wherein an output power of the laser pump source is approximately 6 watts at a conversion efficiency of between and including approximately 45% and 65%.

Example 10 includes a DPSSL of example 1, wherein dimensions of the laser pump source are approximately a length of 4 mm, a width of 3 mm, and a height of 0.5 mm.

Example 11 includes a DPSSL of example 1, wherein the PBC comprises at least one refractive optical element.

Example 12 includes a DPSSL of example 1, wherein the PBC comprises at least one diffractive optical element.

Example 13 includes a DPSSL of example 1, wherein the PBC includes a lens.

Example 14 includes a DPSSL of example 13, wherein dimensions of the lens are 1 mm×0.5 mm×0.4 mm.

Example 15 includes a DPSSL of example 14, wherein a radius of curvature of a first surface of the lens is approximately 0.4 mm and a radius of curvature of a second surface of the lens is approximately 1.5 mm.

Example 16 includes a DPSSL of example 1, wherein the PBC includes at least one fast-axis lens.

Example 17 includes a DPSSL of example 16, wherein a fast-axis lens has a focal length 0.286 mm and dimensions of approximately 1.5 mm×0.5 mm×0.5 mm.

Example 18 includes a laser of example 1, wherein the PBC includes at least one slow-axis lens.

Example 19 includes a DPSSL of example 18, wherein a slow-axis lens has a focal length 0.9 mm and dimensions of approximately 1.6 mm×1.2 mm×2 mm.

Example 20 includes a DPSSL of example 1, wherein the laser gain medium comprises an Nd:YVO₄ crystal.

Example 21 includes a DPSSL of example 20, wherein the Nd:YVO₄ crystal length is approximately 4 mm, with an Nd³⁺ doping level of approximately 0.5 at. %.

Example 22 includes a DPSSL of example 20, wherein the Nd:YVO₄ crystal length is between and including approximately 1 mm and 8 mm, with a Nd³⁺ doping level is between and including approximately 0.2 at. % and 2 at. %.

Example 23 includes a DPSSL of example 1, wherein the laser gain medium has a fluorescence bandwidth of approximately 1 nm at a peak wavelength of approximately 1064 nm.

Example 24 includes a DPSSL of example 1, wherein the laser gain medium comprises one of the following: an Nd:YAG crystal, an Nd:CALGO crystal, a Yb:YAG crystal, a Yb:KYW crystal, a Yb:CALGO crystal, or a Yb:YVO₄ crystal.

Example 25 includes a DPSSL of example 1, wherein the laser gain medium includes a pump beam, wherein a radius of the pump beam is between and including approximately 50 microns and 200 microns.

Example 26 includes a DPSSL of example 1, further comprising a heat sink coupled with the laser gain medium.

Example 27 includes a DPSSL of example 26, wherein the laser gain medium comprises a metallized surface, and wherein the heat sink is soldered to the metallized surface.

Example 28 includes a DPSSL of example 26, wherein the metallized surface comprises one of Ti/Pt/Au, Cr/Ni/Au or Ni/Au.

Example 29 includes a DPSSL of example 27, wherein solder comprises one of InSn solder, In solder, AuSn solder, InAg solder or SAC solder.

Example 30 includes a DPSSL of example 26, wherein a height of the laser gain medium is between and including approximately 0.5 mm and 3 mm.

Example 31 includes a DPSSL of example 1, further comprising a laser base coupled with the laser gain medium.

Example 32 includes a DPSSL of example 31, wherein an epoxy couples the laser gain medium with the laser base.

Example 33 includes a DPSSL of example 1, wherein the laser gain medium includes a coating, and wherein the coating comprises one of the following: Ta₂O₅/SiO₂, TiO₂/SiO₂, and/or HfO₂/SiO₂.

Example 34 includes a DPSSL of example 1, wherein a coating of a first surface of the laser gain medium comprises an anti-reflector (AR) coating and a coating of a second surface of the laser gain medium comprises a high-reflector (HR) coating.

Example 35 includes a DPSSL of example 1, wherein a coating of a first surface of the laser gain medium comprises an HR coating and a coating of a second surface of the laser gain medium comprises an AR coating.

Example 36 includes a DPSSL of example 1, wherein a coating of a first surface of the SHG and a second surface of the SHG comprise an AR coating.

Example 37 includes a DPSSL of example 1, wherein a coating of a first surface of the SHG comprises an HR coating and a coating of a second surface of the SHG comprises an AR coating.

Example 38 includes a DPSSL of example 1, wherein a coating of a first surface of the output coupler comprises an HR coating and a coating of a second surface of the output coupler comprises an AR coating.

Example 39 includes a DPSSL of example 1, wherein the SHG comprises a SHG crystal.

Example 40 includes a DPSSL of example 39, wherein the SHG crystal comprises one of the following: a periodically poled lithium niobate (PPLN) crystal, a periodically poled lithium tantalate (PPLT) crystal, or a periodically poled potassium titanyl phosphate (PPKTP) crystal.

Example 41 includes a DPSSL of example 39, wherein IR light is frequency-doubled in the SHG crystal.

Example 42 includes a DPSSL of example 39, wherein the SHG crystal is chirped.

Example 43 includes a DPSSL of example 42, wherein the SHG crystal is chirped by linearly chirping the grating period across the SHG length.

Example 44 includes a DPSSL of example 42, wherein the SHG crystal comprises a chirped PPLN crystal.

Example 45 includes a DPSSL of example 44, wherein a length of the chirped PPLN crystal is approximately 2 mm with a linearly chirped grating.

Example 46 includes a DPSSL of example 45, wherein an initial grating period is approximately 6.89 microns and a final grating period is approximately 7.01 microns and 50% duty cycle.

Example 47 includes a DPSSL of example 46, wherein a center wavelength is approximately 532 nm.

Example 48 includes a DPSSL of example 44, wherein a length of chirped PPLN crystal is between and including approximately 1 mm and 3 mm.

Example 49 includes a DPSSL of example 42, wherein the SHG crystal comprises one of the following: a chirped PPLN crystal, a chirped PPLT crystal, and a chirped PPKTP crystal.

Example 50 includes a DPSSL of example 1, wherein the output coupler comprises a plano-concave output coupler.

Example 51 includes a DPSSL of example 1, wherein dimensions of the output coupler are approximately 2 mm×2 mm×0.5 mm.

Example 52 includes a DPSSL of example 1, wherein a radius of curvature of the output coupler is between and including approximately 35 mm and 100 mm.

Example 53 includes a DPSSL of example 52, wherein a radius of curvature is approximately 85 mm.

Example 54 includes a DPSSL of example 1, wherein approximate mechanical characteristics of the DPPSL are length=21 mm; width=8 mm; height=3.8 mm; and mass=1.5 g.

Example 55 includes a solid state laser system, comprising: a pump source that includes a wavelength stabilizer; a laser medium positioned after the pump source, wherein said laser medium comprises Nd:YVO₄ having a near uniform Nd³⁺ doping level between and including approximately 0.2 at. % and 2 at. %; a frequency doubler positioned after the laser medium.

Example 56 includes the laser system of claim 55, wherein the laser medium has a length in the range between and including 1 mm and 8 mm.

Example 57 includes the laser system of claim 55, wherein the laser medium has a length of approximately 4 mm.

Example 58 includes the laser system of claim 55, wherein the frequency doubler is a chirped PPLN.

Example 59 includes the laser system of claim 55, wherein the frequency doubler is a PPLT SHG crystal.

Example 60 includes the laser system of claim 55, wherein the frequency doubler is a periodically poled SHG having linearly chirped gratings of at least one of same and different chirp rates.

Example 61 includes a solid state laser system, comprising:

a laser gain medium; an output coupler positioned after the laser gain medium, wherein the output coupler has a first surface that is coated with an HR, and a second surface that is coated with an AR, wherein the first surface has a radius of curvature of approximately 85 mm, and wherein the output coupler is a plano-concave output coupler.

Example 62 includes the laser system of claim 61, wherein the output coupler is positioned after the laser gain medium.

Example 63 includes the laser system of claim 61, further comprising a frequency doubler, and wherein the frequency doubler is positioned between the output coupler and the laser medium.

Example 64 includes the laser system of claim 61, further comprising a frequency doubler, and wherein the frequency doubler is positioned after the output coupler.

Example 65 includes the laser system, comprising: a pump source that pumps light at a pump wavelength; a laser gain medium positioned after the pump source and having a first surface and a second surface, wherein the lasing medium generates light at an intracavity lasing wavelength, and wherein the first surface is an AR at the pump wavelength, and wherein the second surface is an AR at the intracavity lasing wavelength and at least one of an AR and HR at the pump wavelength.

Example 66 includes the laser system of claim 65, wherein the pump source has a power output of approximately 6 W.

Example 67 includes the laser system of claim 65, wherein the pump source wavelength is approximately 880 nm.

Example 68 includes the laser system of claim 65, wherein the second surface is an AR at the intracavity lasing wavelength and an HR at the pump wavelength.

Example 69 includes the laser system of claim 65, wherein at least one of the AR and the HR is an oxidized version of at least one of Ta, Si, Ti, and HF.

Example 70 the laser system of claim 65, further comprising an SHG crystal positioned after the laser gain medium, wherein the SHG crystal doubles the intracavity wavelength of approximately 1064 nm and generates light at approximately 532 nm.

Example 71 includes the laser system of claim 65, further comprising a pump beam coupler positioned after the pump source, wherein the pump beam coupler includes a beam shaping element that is a plano-convex cylindrical lens.

Example 72 includes the laser system of claim 65, wherein the laser medium has an absorption bandwidth in a range between and including approximately 2 nm and 6nm.

Example 73 includes the laser system of claim 65, wherein the laser medium has an absorption bandwidth of approximately 3.8 nm.

Example 74 includes the laser system of claim 65, wherein the pump source outputs power in a range between and including approximately 3 W and 10 W.

What is claimed is:

1. A solid state laser system, comprising:
a pump source that includes a wavelength stabilizer that is integrated into the pump source;
a laser medium positioned after the pump source, wherein said laser medium comprises Nd:YVO4 having a near uniform Nd3+ doping level between and including approximately 0.2 at. % and 2 at. %;
a frequency doubler positioned after the laser medium.

2. The laser system of claim 1, wherein the laser medium has a length in the range between and including 1 mm and 8 mm.

3. The laser system of claim 1, wherein the laser medium has a length of approximately 4 mm.

4. The laser system of claim 1, wherein the frequency doubler is a chirped PPLN.

5. The laser system of claim 1, wherein the frequency doubler is a PPLT SHG crystal.

6. The laser system of claim 1, wherein the frequency doubler is a periodically poled SHG having linearly chirped gratings of at least one of same and different chirp rates.

7. A solid state laser system, comprising:
a laser gain medium;
an output coupler positioned after the laser gain medium, wherein the output coupler has a first surface that is coated with an HR, and a second surface that is coated with an AR, wherein the first surface has a radius of curvature of approximately 85 mm, and wherein the output coupler is a plano-concave output coupler.

8. The laser system of claim 7, wherein the output coupler is positioned after the laser gain medium.

9. The laser system of claim 7, further comprising a frequency doubler, and wherein the frequency doubler is positioned between the output coupler and the laser medium.

10. The laser system of claim 7, further comprising a frequency doubler, and wherein the frequency doubler is positioned after the output coupler.

11. A laser system, comprising:
a pump source that pumps light at a pump wavelength;
a laser gain medium positioned after the pump source and having a first surface and a second surface, wherein the lasing medium generates light at an intracavity lasing wavelength, and wherein the first surface is an AR at the pump wavelength, and wherein the second surface is an AR at the intracavity lasing wavelength and at least one of an AR and HR at the pump wavelength.

12. The laser system of claim 11, wherein the pump source has a power output of approximately 6 W.

13. The laser system of claim 11, wherein the pump source wavelength is approximately 880 nm.

14. The laser system of claim 11, wherein the second surface is an AR at the intracavity lasing wavelength and an HR at the pump wavelength.

15. The laser system of claim 11, wherein at least one of the AR and the HR is an oxidized version of at least one of Ta, Si, Ti, and HF.

16. The laser system of claim 11, further comprising an SHG crystal positioned after the laser gain medium, wherein the SHG crystal doubles the intracavity wavelength of approximately 1064 nm and generates light at approximately 532 nm.

17. The laser system of claim 11, further comprising a pump beam coupler positioned after the pump source, wherein the pump beam coupler includes a beam shaping element that is a plano-convex cylindrical lens.

18. The laser system of claim 11, wherein the laser medium has an absorption bandwidth in a range between and including approximately 2 nm and 6 nm.

19. The laser system of claim 11, wherein the laser medium has an absorption bandwidth of approximately 3.8 nm.

20. The laser system of claim 11, wherein the pump source outputs power in a range between and including approximately 3 W and 10 W.

21. A solid state laser system, comprising:
a pump source that includes a wavelength stabilizer that is integrated into the pump source;
a laser medium positioned after the pump source, wherein said laser medium comprises Nd:YVO4 having a near uniform Nd3+ doping level that is greater than or equal to 0.2 at. % and less than 0.4 at. %;
a frequency doubler positioned after the laser medium.

22. A solid state laser system, comprising:
a pump source that includes a wavelength stabilizer;
a laser medium positioned after the pump source, wherein said laser medium comprises Nd:YVO4 having a near uniform Nd3+ doping level that is greater than or equal to 0.2 at. % and less than 0.4 at. %;
a frequency doubler positioned after the laser medium.
